(19) United States
(12) Patent Application Publication
(10) Pub. No.: US 2014/0091507 A1
(43) Pub. Date: Apr. 3, 2014

(54) BUSHINGS FOR VEHICLE SUSPENSION

(71) Applicant: Redranger Pty Ltd, Somersby (AU)

(72) Inventor: Lloyd Neil OLDFIELD, Huntington Beach, CA (US)

(73) Assignee: Redranger Pty Ltd, Somersby (AU)

(21) Appl. No.: 14/031,868

(22) Filed: Sep. 19, 2013

Related U.S. Application Data
(60) Provisional application No. 61/707,238, filed on Sep. 28, 2012.

(51) Int. Cl. B60G 11/22

(52) U.S. Cl. CPC B60G 11/22
USPC 267/292

(57) ABSTRACT

Described the embodiments generally relate to bushings for vehicle suspensions. In particular, described embodiments relate to bushings for applications that can involve extreme articulation of the vehicle suspension, or for applications involving the transport of heavy payloads, off-road sporting vehicles and vehicles with modified suspensions. Described embodiments relate to one-piece bushings, as well as two-piece bushings.

### TECHNICAL FIELD

Described the embodiments generally relate to bushings for vehicle suspensions. In particular, described embodiments relate to bushings for applications that can involve extreme articulation of the vehicle suspension, or for applications involving the transport of heavy payloads, off-road sporting vehicles and vehicles with modified suspensions. Described embodiments relate to one-piece bushings, as well as two-piece bushings.

### BACKGROUND

Vehicle suspension bushings for mass production vehicles are relatively standardised and are generally not designed to accommodate stresses associated with extreme articulation of the vehicle suspension.

For vehicles with modified suspensions or suspensions required to accommodate rugged off-road conditions, suspension bushings for such vehicles can be either overly rigid, leading to a rougher and less enjoyable driving experience. In some instances, the bushings are not rigid enough, which can allow intrusion of grit or other debris into gaps allowed by soft inner bushing material. Such grit or debris can lead to early failure of the bushing.

It is desired to address or ameliorate one or more shortcomings or disadvantages associated with existing bushings for vehicle suspensions, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a bushing for a vehicle suspension, comprising:
a first rigid sleeve;
a first elastomeric layer affixed to an inside of the first sleeve;
a second rigid sleeve affixed to an inside of the first elastomeric layer; and
a second rigid elastomeric layer affixed to an inside of the second sleeve.

One or both of the first and second rigid sleeves may be metallic. The first elastomeric layer may be bonded to the first sleeve. The second sleeve may be bonded to the first elastomeric layer. The second elastomeric layer may be bonded to the second sleeve. The second sleeve may be flanged at opposed first and second ends.

The second elastomeric layer may be outwardly flanged at opposed first and second ends to at least partially overlie the flanged first and second ends of the second sleeve. The flanged first and second ends of the second sleeve may at least partially overlie opposed first and second ends of the first elastomeric layer.

A durometer of the second elastomeric layer may be higher than a durometer of the first elastomeric layer. The second elastomeric layer may be hollow to snugly accommodate a tube or rod in a freely rotating manner.

The first sleeve, the second sleeve, the first elastomeric layer and the second elastomeric layer may be coaxially and/or concentrically arranged.

The first elastomeric layer may have a greater radial thickness than the second elastomeric layer. The first elastomeric layer may comprise one of a rubber material and a polyurethane material. The second elastomeric layer may comprise a polyurethane material.

The second elastomeric layer may comprise axially directed crennelations formed in opposed first and second ends where the second elastomeric layer may abut a clevis.

At least one of the first rigid sleeve and the second rigid sleeve may be formed of metal. Alternatively, at least one of the first rigid sleeve and the second rigid sleeve may be formed of nylon, such as nylon 6-6.

Some embodiments relate to a two-part bushing for a vehicle suspension, comprising:
a first bushing part and an opposable second part, each having a first end and an opposite second end, the first and second bushing parts forming the bushing when opposed at their first ends;
wherein each of the first and second bushing parts comprise an inner rigid sleeve, an intermediate elastomeric layer affixed to the inner sleeve and an outer rigid sleeve affixed to the intermediate elastomeric layer.

The outer rigid sleeve may comprise a metal sleeve and the bushing may further comprise an outer elastomeric layer affixed to the outer rigid sleeve. At least one of the inner rigid sleeve and the outer rigid sleeve may comprise a nylon material.

The bushing further may comprise an inner elastomeric layer disposed radially inside the inner sleeve and affixed to the inner sleeve. The inner elastomeric layer of the first and second bushing parts may project axially beyond the inner sleeve. The inner sleeve of each of the first and second bushing parts may be flanged at the second end. The inner elastomeric layer of each of the first and second bushing parts may be outwardly flanged at the second end to at least partially overlie the flanged inner sleeve.

The outer sleeve of each of the first and second bushing parts may have a radially outwardly extending flange disposed toward the second end of the respective first and second bushing part.

The inner elastomeric layer of each of the first and second bushing parts may comprise axially directed crennelations at the second end.

The first and second bushing parts may comprise mating keying structure to cause the first and second bushing parts to rotate together when the first and second bushing parts are opposed and abutting at their first ends. The keying structure may be defined by the intermediate elastomeric layer of each first and second part. The inner sleeve may comprise the keying structure.

Some embodiments relate to a bushing part for a vehicle suspension, comprising:
a tubular body having opposed first and second ends;
wherein the first end is radially outwardly flanged and arranged, in use, to abut a clevis of the vehicle suspension;
wherein the tubular body comprises crennelations formed in the flanged first end, the flanged first end comprising an elastomeric material that permits elastic deformation of the crennelations in response to frictional engagement with the clevis.

The bushing part may further comprise a cylindrical metal sleeve extending within the tubular body. The tubular body may be formed of the elastomeric material. The crennelations may extend radially outwardly. The crennelations may be formed around at least an outer radial portion of the flanged first end. The crennelations may also or alternatively be formed around at least an inner radial portion of the flanged first end.

The tubular body may comprise an elastomeric material of a first durometer at the first end and an elastomeric material of a second durometer at the second end, wherein the first durometer is less than the second durometer.

Some embodiments relate to a bushing for a vehicle suspension, comprising:
a first rigid outer sleeve;
an elastomeric layer affixed to an inside of the first sleeve and defining a central bore of the bushing; and
at least two coaxial second rigid sleeves affixed to the elastomeric layer and disposed one at each opposed longitudinal end of the bushing.

The elastomeric layer may be a composite layer comprising a first elastomeric layer and a second elastomeric layer, wherein the second elastomeric layer is affixed to the first elastomeric layer and defines the central bore of the bushing. The coaxial rigid sleeves may have substantially the same diameter.

### BRIEF DESCRIPTION OF THE DRAWINGS

Embodiments are described in further detail below, by way of example and with reference to the accompanying drawings, in which:

FIG. 1A is a perspective view of a bushing according to some embodiments;

FIG. 1B is an end view of the bushing of FIG. 1A;

FIG. 1C is a cross-sectional view of the bushing of FIG. 1B, taken along line A-A of FIG. 1B;

FIG. 2A is a perspective view of one part of a two-part bushing, where both parts are the same;

FIG. 2B is one end view of the bushing part shown in FIG. 2A;

FIG. 2C is an opposite end view of the bushing part shown in FIG. 2A;

FIG. 2D is a cross-sectional view of the bushing part shown in FIG. 2A, taken along line A-A of FIG. 2C;

FIG. 3A is a perspective view of one part of a two-part bushing according to some embodiments, where each bushing part is the same;

FIG. 3B is one end view of the bushing part shown in FIG. 3A;

FIG. 3C is a cross-sectional view of the bushing part shown in FIG. 3A, taken along line A-A of FIG. 3B;

FIG. 4A is a perspective view of one part of a two-part bushing according to some embodiments, where each bushing part is the same;

FIG. 4B is one end view of the bushing part shown in FIG. 4A;

FIG. 4C is a cross-sectional view of the bushing part shown in FIG. 4A, taken along line A-A of FIG. 4B.

FIG. 5A is a perspective view of one part of a two-part bushing according to some embodiments, where each bushing part is the same apart from different keying structure;

FIG. 5B is a perspective view of the bushing part of FIG. 5A, seen from an opposite side;

FIG. 5C is one end view of the bushing part shown in FIG. 5A;

FIG. 5D is a cross-sectional view of the bushing part shown in FIG. 5A, taken along line V-V of FIG. 5C;

FIG. 5E is a cross-sectional view of the bushing part shown in FIG. 5A, taken along a line perpendicular to line V-V of FIG. 5C;

FIG. 6A is a cross-sectional view showing mating keying structure of two of the bushing parts shown in FIG. 5A;

FIG. 6B is a close-up view of part of FIG. 6A;

FIG. 7A is a perspective view of part of a suspension arm with two bushing parts held in an aperture of the arm; and

FIG. 7B is a cross-sectional view of the suspension arm shown in FIG. 7A, showing the arrangement of the bushing parts in the aperture of the arm.

FIG. 8A is a perspective view of a bushing according to some embodiments;

FIG. 8B is an end view of the bushing of FIG. 8A;

FIG. 8C is a cross-sectional view of the bushing of FIG. 8B, taken along line A-A of FIG. 8B;

FIG. 9A is a perspective view of a bushing according to some embodiments;

FIG. 9B is an end view of the bushing of FIG. 9A;

FIG. 9C is a cross-sectional view of the bushing of FIG. 9B, taken along line A-A of FIG. 9B; and

FIG. 9D is a cross-sectional view of the bushing of FIG. 9B, taken along line B-B of FIG. 9B.

### DETAILED DESCRIPTION

Described the embodiments generally relate to bushings for vehicle suspensions. In particular, described embodiments relate to bushings for vehicle applications involving carriage of heavy payloads (e.g. in mining vehicles), modified suspensions, high performance requirements or extreme articulation of the vehicle suspension. Described bushings may have particular application in off-road, four-wheel-drive and sport-driving vehicles. Described embodiments relate to one-piece bushings, as well as two-piece bushings.

Described compositional or structural bushing features may be applied individually or collectively across the various described bushing embodiments. Accordingly, the embodiments depicted in the drawings are illustrative of only some of the embodiments encompassed by this description. Additionally, described embodiments may be subject to some modification to suit a particular application. For example, described features of the bushing embodiments may be selected to improve durability for heavy payloads and motor sport and for vehicle subject to heavy off-road use, such as in mining vehicles.

The described embodiments of bushings are generally intended for use in the specialty market for vehicles having modified suspensions or suspension systems that are likely to experience extreme articulation, for example where significant twisting forces may be applied to the vehicle suspension during operation of the vehicle.

Although the term “bushing” is used herein to refer to a commonly used suspension component that is held at an end of a suspension arm and commonly bracketed by a clevis and/or pierced by a clevis pin, such bushings may also be considered in some instances to function as bearings to allow relative rotation of the suspension arm with respect to the vehicle chassis.

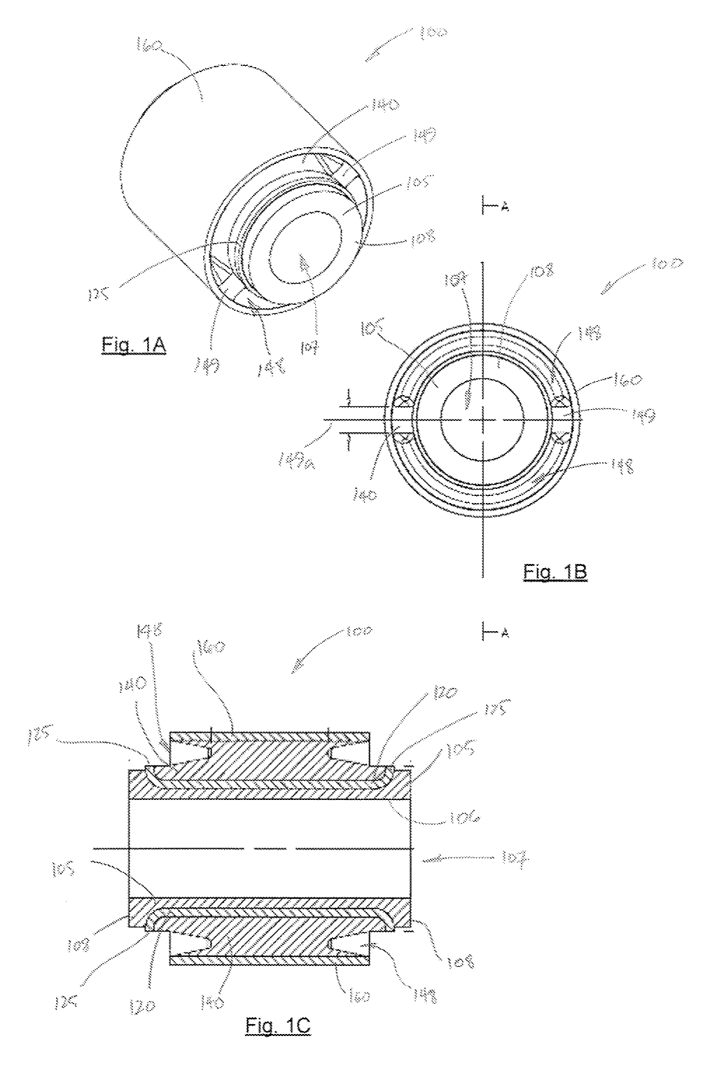

Referring in particular to FIGS. 1A, 1B and 1C, a bushing 100 according to some embodiments is described in further detail. Bushing 100 comprises an inner elastomeric layer 105 that has an internal substantially cylindrical wall surface 106 defining a central bore 107. The inner elastomeric layer 105 has radially outwardly flanged end portions 108 at opposed first and second end portions of the bushing 100.

Bushing 100 further comprises an inner metal sleeve 120 bonded or otherwise affixed to an outside of the inner elastomeric layer 105. This metal sleeve 120 has radially outwardly curving flanges 125 at each opposite end of the bushing 100. These radially outwardly curving flanges 125 generally nest in under the flanges 108 of the inner elastomeric layer 105, which also project radially outwardly.

Bushing 100 further comprises a second, intermediate elastomeric layer 140 that is bonded or otherwise affixed to the outside of the inner metal sleeve 120. Bushing 100 further comprises an outer metal sleeve 160 that is bonded or otherwise affixed to an outside of the intermediate elastomeric layer 140.

The inner elastomeric layer 105, the inner sleeve 120, the intermediate elastomeric layer 140 and the outer sleeve 160 are all generally co-axial and concentric about the bore 107. The outer sleeve 160 is to be received within a bore of a suspension arm (not shown) in a tight interference fit and a suitable clevis pin (not shown) is to be received within bore 107 in order to couple the suspension arm to a part of the vehicle undercarriage.

The inner and outer sleeves 120, 160 may be formed of hollow steel tubes, for example, while the inner and intermediate elastomeric layers 105, 140 may be formed of softer and more flexible materials, for example. In some embodiments, inner and outer sleeves 120, 160 may be formed of other rigid materials, such as non-ferrous metals or rigid plastics, for example. A specific non-metallic material of inner sleeve 120 and/or outer sleeve 160 in some embodiments is nylon, a suitable example of which is nylon 6-6. In some embodiments, one of inner sleeve 120 and outer sleeve 160 may be formed of a rigid metal while the other of inner sleeve 120 and outer sleeve 160 may be formed of a non-metal, such as nylon 6-6. Preferably, the durometer of the intermediate elastomeric layer 140 is less than the durometer of the inner elastomeric layer 105. Where the intermediate elastomeric layer 140 has a lower durometer, it provides the bushing 100 with better cushioning and flexion in response to articulation forces applied to the suspension. At the same time, the rigidity of the inner sleeve 120 avoids the tendency for a gap to form between the clevis pin and the inner elastomeric layer 105 when large twisting forces are applied to the bushing 100.

In some embodiments, the elastomeric layers described herein may comprise synthetic elastomers, such as polyurethane materials (either open cast or thermoformed) or may comprise rubber materials, for example. Some embodiments may use one type of elastomeric material in one layer and another type of elastomeric material in another layer. For example, inner elastomeric layer 105 may be formed of a urethane material, while intermediate elastomeric layer 140 may be formed of a rubber material.

As shown in FIGS. 1A, 1B and 1C, bushing 100 has the intermediate elastomeric layer 140 formed to have channels extending in a lengthwise direction and partially circumferentially. These channels 148 may be diametrically opposed and are separated by lands 149. The channels 148 and lands 149 serve to allow greater flexion of the outer sleeve 160 relative to the inner sleeve 120 in certain axes of rotation, while decreasing the degree of flexion permitted about an axis generally perpendicular to a plane 149a (FIG. 1B) extending through a centre of the lands 149.

The inner elastomeric layer 105 may have a knurl formed on the inside wall 106 in order to accommodate and retain lubricant between the wall 106 and the clevis pin (or other rod) extending through bore 107. Alternatively, the inner wall 106 may have a PTFE (Teflon) fabric lining attached during the moulding process to act as a friction-reduction lining material surrounding the bore 107.

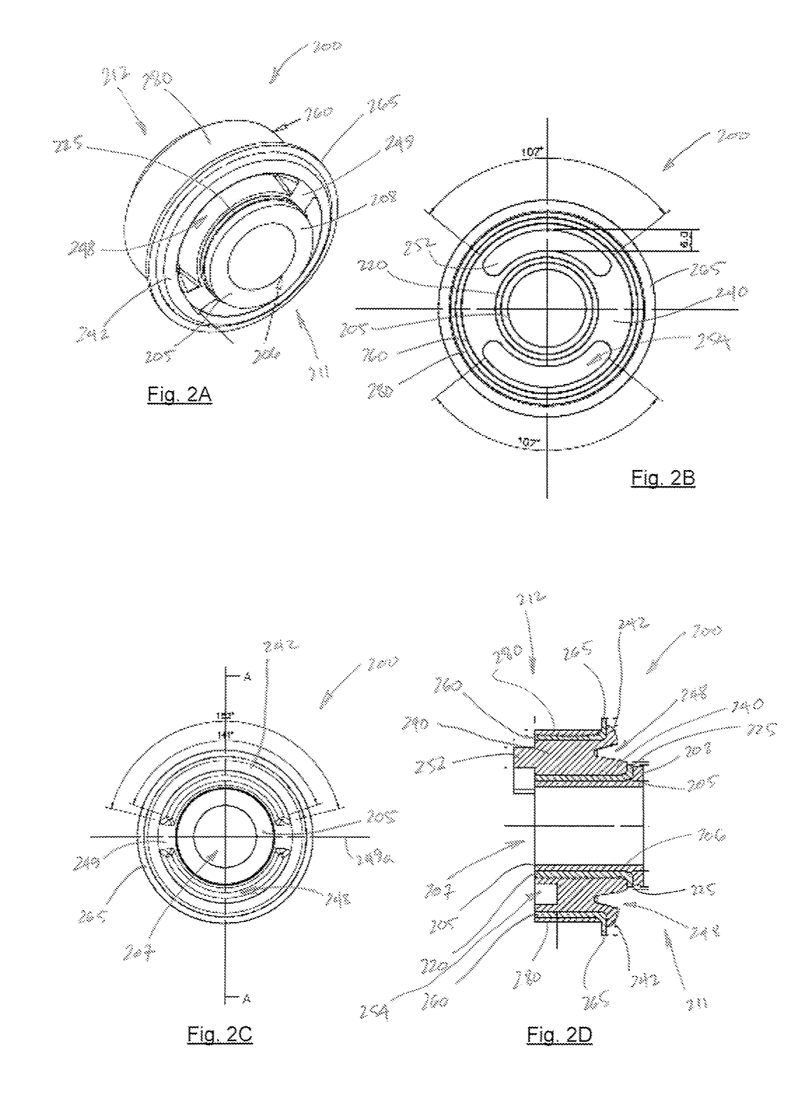

Referring now to FIGS. 2A, 2B, 2C and 2D, a bushing part 200 of a two-piece bushing according to some embodiments is described in further detail. Bushing part 200 comprises an inner elastomeric layer 205 that has an internal substantially cylindrical wall surface 206 defining a central bore 207. The inner elastomeric layer 205 has a radially outwardly flanged end portion 208 at a first end 211 of the bushing part 200.

Bushing part 200 further comprises an inner metal sleeve 220 bonded or otherwise affixed to an outside of the inner elastomeric layer 205. This metal sleeve 220 has radially outwardly curving flanges 225 at the first end 211 of the bushing part 200. This radially outwardly curving flange 225 generally nests in under the flange 208 of the inner elastomeric layer 205, which also projects radially outwardly.

Bushing part 200 further comprises a second, intermediate elastomeric layer 240 that is bonded or otherwise affixed to the outside of the inner metal sleeve 220. Bushing part 200 further comprises an outer metal sleeve 260 that is bonded or otherwise affixed to an outside of the intermediate elastomeric layer 240. Bushing part 200 further comprises a third, outer elastomeric layer 280 that is bonded or otherwise affixed to the outside of the outer metal sleeve 260. The outer elastomeric layer 280 is provided to facilitate installation of the two part bushing 200 by human hand as an alternative to convention metal or rigid plastic design outer casings (shells) that require the force of a mechanical press for installation. A metal or rigid shelled bushing might tend to rattle and wear would occur at the metal-to-metal or metal-to-rigid-plastic contact areas.

Intermediate layer 240 has a flanged portion 242 that extends radially outwardly to overlie part of a flanged portion 265 of the outer metal sleeve 260. Flanged portion 265 also extends radially outwardly but is not covered by outer elastomeric layer 280, which ends at the point where the flanged portion 265 extends outwardly.

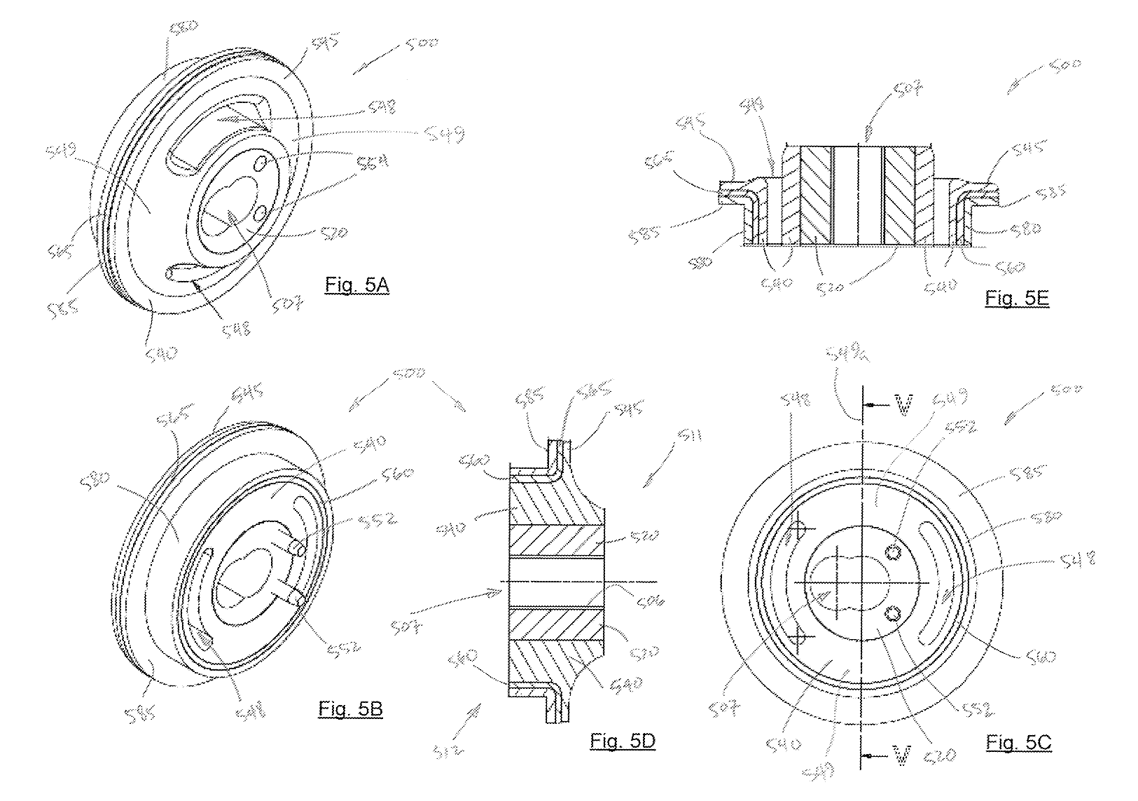

At a second end 212 of the bushing part 200, the ends of the inner elastomeric layer 205, the inner sleeve 220, the intermediate elastomeric layer 240, the outer sleeve 260 and the outer elastomeric layer 280 generally form a flat surface, apart from recessed and projecting mating keying structure 254, 252. When the second ends of respective bushing parts 200 are abutted and rotated relative to one another, the projection 252 of one part extends into the recess 254 of the other part, thereby keying the two parts together so that relative rotational movement does not occur. As shown in FIGS. 2B and 2D, the projection 252 and recess 254 are formed to extend partially circumferentially around opposite diametrical sides of the bushing part 200. However, as shown and described below in relation to FIGS. 5A to 5E, 6A and 6B, other forms of keying structure may be employed to fix the two bushing parts against relative rotation.

The inner elastomeric layer 205, the inner sleeve 220, the intermediate elastomeric layer 240 and the outer sleeve 260 are all generally co-axial and concentric about the bore 207. The outer elastomeric layer 280 is to be received within a bore of a suspension arm (not shown) in a manually insertable snug fit and a suitable clevis pin (not shown) is to be received within the bore 207 (of both parts 200 when mated together) in order to couple the suspension arm to a part of the vehicle undercarriage.

The inner and outer sleeves 220, 260 may be formed of hollow steel tubes or other rigid metallic or non-metallic tube materials (or parts thereof), for example, while the inner, intermediate and outer elastomeric layers 205, 240 and 280 may be formed of softer and more flexible materials, for example. A specific non-metallic material of inner sleeve 220 and/or outer sleeve 260 in some embodiments is nylon, a suitable example of which is nylon 6-6. In some embodiments, one of inner sleeve 220 and outer sleeve 260 may be formed of a rigid metal while the other of inner sleeve 220 and outer sleeve 260 may be formed of a non-metal, such as nylon 6-6. Preferably, the durometer of the intermediate elastomeric layer 240 is less than the durometer of the inner elastomeric layer 205. The durometer of the intermediate elastomeric layer 240 may also be less than the durometer of the outer elastomeric layer 280. Where the intermediate elastomeric layer 240 has a lower durometer, it provides the bushing part 200 with better cushioning and flexion in response to articulation forces applied to the suspension. At the same time, the rigidity of the inner sleeve 220 avoids the tendency for a gap to form between the clevis pin and the inner elastomeric layer 205 when large twisting forces are applied to the bushing parts 200 (when assembled together to form a single bushing).

For embodiments of bushing parts 200 that employ a nylon material as outer sleeve 260, the outer elastomeric layer 280 may be omitted.

In some embodiments, the elastomeric layers described herein may comprise synthetic elastomers, such as polyurethane materials (either open cast or thermoformed) or may comprise rubber materials, for example. Some embodiments may use one type of elastomeric material in one layer and another type of elastomeric material in another layer. For example, inner elastomeric layer 205 may be formed of a urethane material, while intermediate elastomeric layer 240 may be formed of a rubber material.

As shown in FIGS. 2A, 2C and 2D, bushing part 200 has the intermediate elastomeric layer 240 formed to have channels extending in a lengthwise direction and partially circumferentially in the first end 211. These channels 248 may be diametrically opposed and are separated by lands 249. The channels 248 and lands 249 serve to allow greater flexion of the outer sleeve 260 relative to the inner sleeve 220 in certain axes of rotation, while decreasing the degree of flexion permitted about an axis generally perpendicular to a plane 249a (FIG. 2C) extending through a centre of the lands 249.

The inner elastomeric layer 205 may have a knurl formed on the inside wall 206 in order to accommodate and retain lubricant between the wall 206 and the clevis pin (or other rod) extending through bore 207. Alternatively, the inner wall 206 may have a PTFE (Teflon) fabric lining attached during the moulding process to act as a friction-reduction lining material surrounding the bore 207.

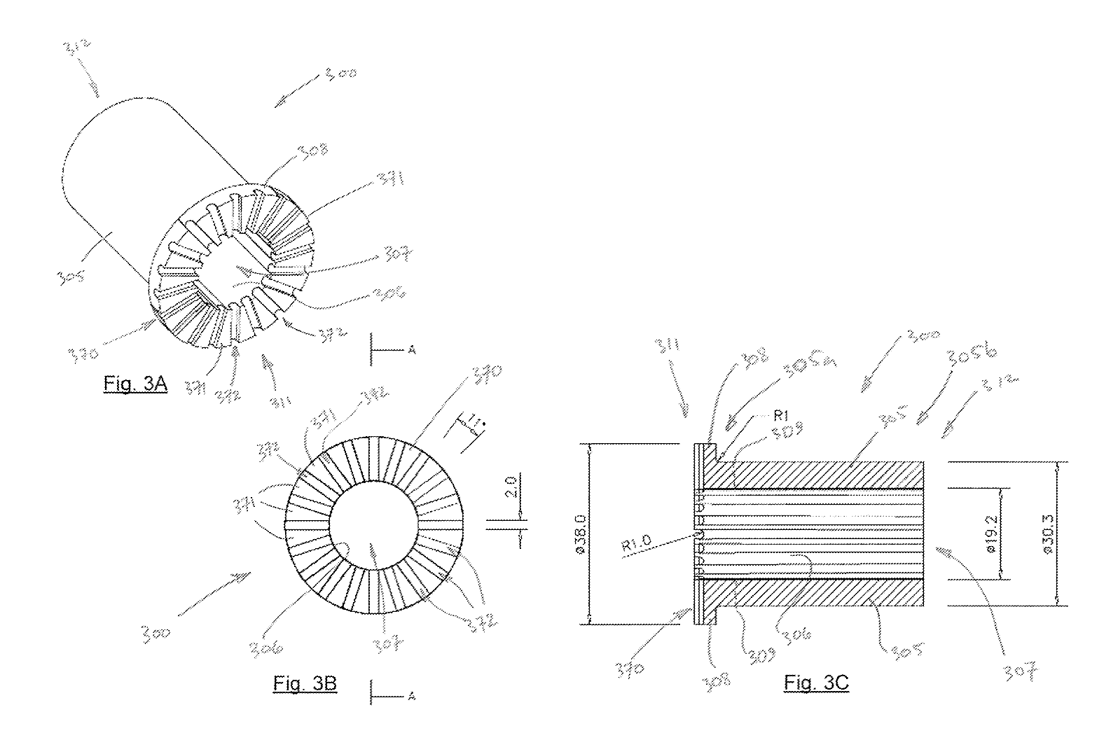

Referring now to FIGS. 3A, 3B, and 3C, a bushing part 300 is shown and described in further detail. Bushing part 300 may form one part of a two part bushing in which both parts 300 are the same. Thus, each bushing part 300 has a first end 311 and a second end 312 and, when the bushing parts 300 are used together to form a complete bushing, the second ends 312 are received within a suspension arm in abutting fashion to form a complete two-part bushing.

Bushing part 300 may have a unitary body 305 formed of a single material, such as an elastomer like a polyurethane material or a rubber material, for example. The bushing part 300 may be moulded to have a radially outwardly extending flange 308 at the first end 311. The elastomeric body 305 effectively forms a single elastomeric layer of the bushing part 300, although in alternative embodiments, the body 305 may partly or wholly enclose a rigid metal tubular sleeve. Body 305 has an internal wall surface 306 that defines a central bore 307 to receive a suitable rod, shaft or clevis pin. The internal wall surface 306 may have a knurl formed therein to accommodate and retain a lubricant. Alternatively, the inner wall 306 may have a PTFE (Teflon) fabric lining attached during the moulding process to act as a friction-reduction lining material surrounding the bore 307.

As is clearly visible in FIGS. 3A and 3B, an outer annular face of the flange portion 308 at the first end 311 has a series of crennelations 370 formed in a radially extending manner about a centre of the bore 307. The crennelations 370 are defined by alternating recessed portions 372 and raised portions 371. The crennelations 370 are preferably formed so as to allow the raised portions 371 to have an appreciable susceptibility for elastic deformation or flexion under frictional engagement with a surface to which it is abutted (such as a clevis part) during use. This is intended to have the effect of reducing squeaking noises due to relative movement of the end face of the bushing 300 against the abutted surface.

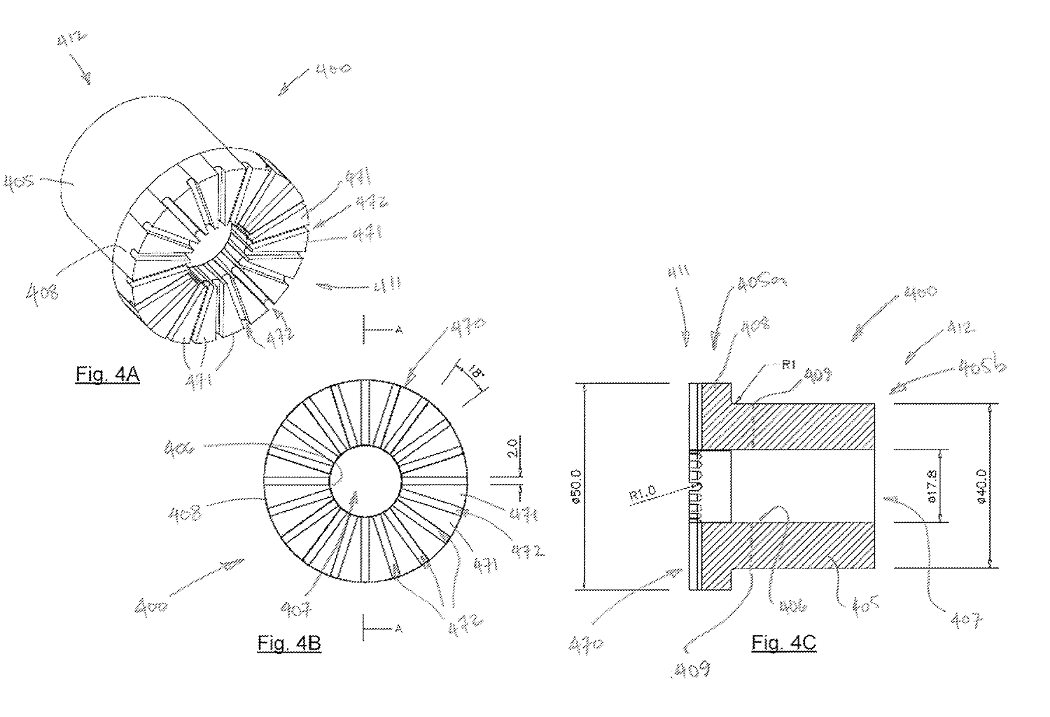

Although the raised portions 371 are shown to resemble wedges and the recessed portions 372 are shown to resemble straight slots in FIGS. 3A and 3B, different shapes may be employed to give effect to the desired function, as described above. Further, the relative height difference between the bottom of each recess 372 and the top of each raised portion 371 may vary across different embodiments, although exemplary embodiments may have a height difference of about 2 millimetres. Also, as is suitably illustrated in FIGS. 4A and 4B, different angular separation of the recessed portion 372 may be used in different embodiments.

In some embodiments, body 305 may be formed to have a first body portion 305a (i.e. the flanged portion and some of the cylindrical portion) at the first end 311 and a second body portion 305b extending from adjacent the first body portion 305a to the second end 312, where the first and second body portions are formed of materials of different hardnesses. For example, the first body portion 305a may have a durometer of around 75 to 80 (Shore A) and the second body portion may have a durometer of around 80 or 85 to 95 (Shore A). The first body portion 305a may be fused or otherwise bonded to the second body portion 305b approximately along line 309 by molding the materials in the same mold in quick succession (e.g. the material to form the first body portion 305a is injected into the mold and then within a matter of seconds the material to form the second body portion 305b is injected to fill out the rest of the mold).

Referring now to FIGS. 4A, 4B, and 4C, a bushing part 400 is shown and described in further detail. Bushing part 400 may form one part of a two part bushing in which both parts 400 are the same. Thus, each bushing part 400 has a first end 411 and a second end 412 and, when the bushing parts 400 are used together to form a complete bushing, the second ends 412 are received within a suspension arm in abutting fashion to form a complete two-part bushing.

Bushing part 400 may have a unitary body formed of a single material, such as an elastomer like a polyurethane material or a rubber material, for example. The bushing part 400 may be moulded to have a regularly outwardly extending flange 408 at the first end 411. The elastomeric body 405 effectively forms a single elastomeric layer of the bushing part 400, although in alternative embodiments, the body 405 may partly or wholly enclose a rigid metal sleeve. Body 405 has an internal wall surface 406 that defines a central bore 407 to receive a suitable rod, shaft or clevis pin. The internal wall surface 406 may have a knurl formed therein to accommodate and retain a lubricant. Alternatively, the inner wall 406 may have a PTFE (Teflon) fabric lining attached during the moulding process to act as a friction-reduction lining material surrounding the bore 407.

As is clearly visible in FIGS. 4A and 4B, an outer annular face of the flange portion 408 at the first end 411 has a series of crennelations 470 formed in a regularly extending manner about a centre of the bore 407. The crennelations 470 are defined by alternating recessed portions 472 and raised portions 471. The crennelations 470 are preferably formed so as to allow the raised portions 471 to have an appreciable susceptibility for elastic deformation or flexion under frictional engagement with a surface to which it is abutted (such as a clevis part) during use. This is intended to have the effect of reducing squeaking noises due to relative movement of the end face of the bushing 400 against the abutted surface.

Although the raised portions 471 are shown to resemble wedges and the recessed portion 472 are shown to resemble straight slots in FIGS. 4A and 4B, different shapes may be employed to give effect to the desired function, as described above. Further, the relative height difference between the bottom of each recess 472 and the top of each raised portion 471 may vary across different embodiments, although exemplary embodiments may have a height difference of about 2 millimetres.

In some embodiments, body 405 may be formed to have a first body portion 405a (i.e. the flanged portion and some of the cylindrical portion) at the first end 411 and a second body portion 405b extending from adjacent the first body portion 405a to the second end 412, where the first and second body portions are formed of materials of different hardnesses. For example, the first body portion 405a may have a durometer of around 75 to 80 (Shore A) and the second body portion may have a durometer of around 80 or 85 to 95 (Shore A). The first body portion 405a may be fused or otherwise bonded to the second body portion 405b approximately along line 409 by molding the materials in the same mold in quick succession (e.g. the material to form the first body portion 405a is injected into the mold and then within a matter of seconds the material to form the second body portion 405b is injected to fill out the rest of the mold).

The bushing parts 300 and 400 are functionally quite similar and serve to illustrate that the bushing part may be formed with different dimensions of thickness and radial extent of the flange 308, 408, different configuration of crennelations 370, 470, as well as different bushing length, wall thickness, and internal and external diameters. Further, bushing parts 300 and 400 may be formed with materials of differing durometer, depending on the required or desired noise and vibration characteristics of the suspension.

Referring now to FIGS. 5A, 5B, 5C, 5D and 5E, a bushing part 500 of a two-piece bushing according to some embodiments is described in further detail. Bushing part 500 is to cooperate with a mating bushing part 501 (FIG. 6B, 7B) that is identical apart from its keying structure. Bushing part 500 comprises an inner rigid sleeve 520 that has an internal non-cylindrical wall surface 506 defining a central bore 507. The inner sleeve 520 is free of any radially outwardly flanged end portion.

The bore 507 may be irregularly shaped to accommodate an irregularly shaped rod or pin therethrough. As shown in FIGS. 5A, 5B and 5C, bore 507 may be shaped to be somewhat rounded or oval, but with an irregular shape that provides two alternate positions for receiving the pin, rod or shaft. This provides an adjustment choice for wheel alignment correction. Bore 507 is shown as having part of the rounded shape of the bore coinciding with a circular centre of the bushing part 500 to receive the pin, rod or shaft in a first position. However, the bore 507 has a geometric centre that is off-set from the centre of the bushing part 500 and defines another rounded section to receive the pin, rod or shaft in an off-set second position.

In bushing part 501, inner sleeve 520 further defines two holes or recesses 554 extending part way or all the way through the inner sleeve 520 to act as mating keying structure to mate with the pins or projections 552 on bushing part 500.

Bushing part 500 further comprises an intermediate elastomeric layer 540 that is bonded or otherwise affixed to the outside of the inner metal sleeve 520. Bushing part 500 further comprises an outer sleeve 560 that is bonded or otherwise affixed to an outside of the intermediate elastomeric layer 540. Outer sleeve 560 may be formed of metal or a non-metal material, such as nylon, an example of which is nylon 6-6. Bushing part 500 further comprises an outer elastomeric layer 580 that is bonded or otherwise affixed to the outside of the outer sleeve 560. The outer elastomeric layer 580 is provided to facilitate installation of the two part bushing 500, 501 by human hand as an alternative to convention metal or rigid plastic design outer casings (shells) that require the force of a mechanical press for installation.

Intermediate layer 540 has a flanged portion 545 that extends radially outwardly to overlie part of a flanged portion 565 of the outer sleeve 560. Flanged portion 565 also extends radially outwardly and is substantially covered on its other side (from portion 545) by a radially outwardly extending portion 585 of outer elastomeric layer 580.

At a second end 512 of the bushing part 500, the ends of the inner sleeve 520, the intermediate elastomeric layer 540, the outer sleeve 560 and the outer elastomeric layer 580 generally form a flat surface, apart from recessed and projecting mating keying structure 554, 552 and bore 507. When the second ends of respective bushing parts 500 and 501 are abutted relative to one another, the projections 552 of part 500 extend into the recesses 554 of the other part 501, thereby keying the two parts together so that relative rotational movement does not occur. As shown in FIGS. 5B, 6A and 6B, the projections 552 are formed as rigid pins that are sized to be received in recesses (or holes) 554 in a close but non-interfering fit.

The inner sleeve 520, the intermediate elastomeric layer 540, the outer sleeve 560 are all generally co-axial and concentric about a part of the bore 507. The outer elastomeric layer 580 is to be received within a bore of a suspension arm 710 in a manually insertable snug fit and a suitable clevis pin or coupling rod (not shown) is to be received within the bore 507 (of both parts 500 and 501 when mated together) in order to couple the suspension arm 710 to a part of the vehicle undercarriage.

The outer sleeve 560 may be formed of hollow steel (or other metal) tubes (or tube sections), for example, while the intermediate and outer elastomeric layers 540 and 580 may be formed of softer and more flexible materials, for example. The inner sleeve 520 may be formed of a light steel or alternatively another metal, such as brass or aluminium. In some embodiments, the durometer of the intermediate elastomeric layer 540 is less than the durometer of the outer elastomeric layer 580. Where the intermediate elastomeric layer 540 has a lower durometer, it provides the bushing (comprising parts 500 and 501) with better cushioning and flexion in response to articulation forces applied to the suspension.

For embodiments of bushing parts 500 and 501 that employ a nylon material as outer sleeve 560, the outer elastomeric layer 580 may be omitted since the nylon allows a small amount of give or deformation to permit manual fitting of the bushing parts 500, 501 without also needing an outer elastomeric layer.

In some embodiments, the elastomeric layers described herein may comprise synthetic elastomers, such as polyurethane materials (either open cast or thermoformed), or may comprise rubber materials, for example. Some embodiments may use one type of elastomeric material in one layer and another type of elastomeric material in another layer. For example, outer elastomeric layer 580 may be formed of a urethane material, while intermediate elastomeric layer 540 may be formed of a rubber material.

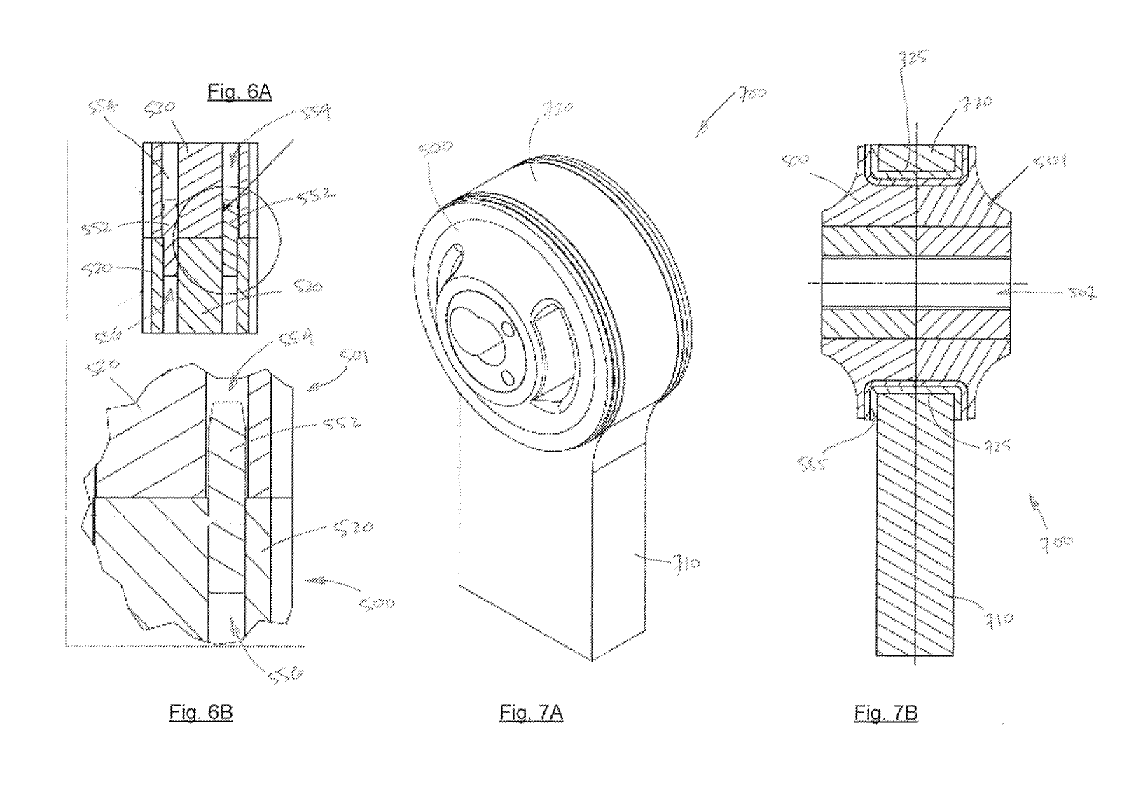

As shown in FIGS. 5A, 5B, 5C, 5E and 7A, bushing part 500 has the intermediate elastomeric layer 540 formed to have channels extending in a lengthwise direction all the way through from the first end 511 to the second end 512 and partially circumferentially. These channels 548 may be diametrically opposed and are separated by lands 549. The channels 548 and lands 549 serve to allow greater flexion of the outer sleeve 560 relative to the inner sleeve 520 in certain axes of rotation, while decreasing the degree of flexion permitted about an axis generally perpendicular to a plane 549a (FIG. 5C) extending through a centre of the lands 549.

As shown in FIGS. 6A and 6B, bushing part 501 has recesses 554 formed of a size to snugly (but not interferingly) fit mating keying structure projections 552 of bushing part 500 when the two parts 500 and 501 are abutted at their second ends 512. The projections 552 may be integrally formed with the inner sleeve 520 or may be affixed thereto by suitable attachment means, for example by a forced interference fit of the projections 552 within holes or apertures 556 formed in inner sleeve 520, as shown in FIGS. 6A and 6B.

FIGS. 7A and 7B illustrate receipt of the bushing parts 500 and 501 in a generally circular aperture defined by a circular inner wall 725 defined by an annular loop of material at the end of the suspension arm 710. As is shown in FIG. 7B, when the bushing parts 500 and 501 are received in the aperture of the suspension arm 710, the outer elastomeric layers 580 of each bushing part 500, 501 are snugly received against the inner wall 725 of the suspension arm end, with the radially outwardly extending flange portions 585 of the outer elastomeric layers 580 overlying parts of the suspension arm 710 adjacent the parts of the suspension arm 710 that define the aperture and inner wall 725.

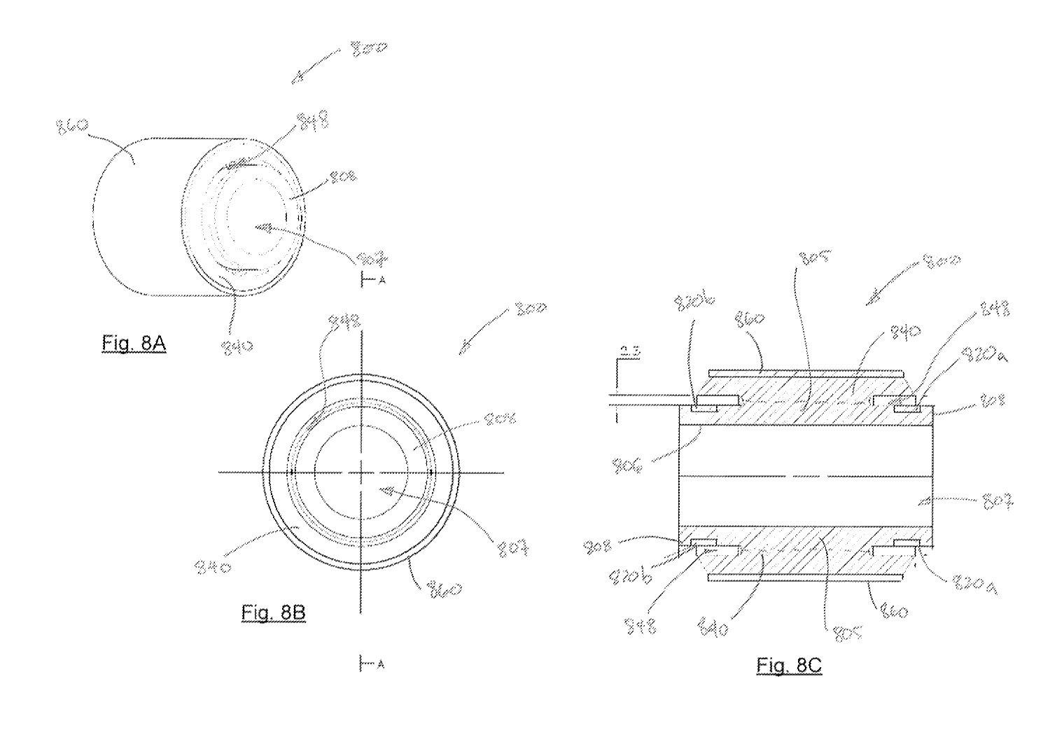

Referring in particular to FIGS. 8A, 8B and 8C, a bushing 800 according to some embodiments is described in further detail. Bushing 800 comprises an inner elastomeric layer 805 that has an internal substantially cylindrical wall surface 806 defining a central bore 807. The inner elastomeric layer 805 has radially outwardly flanged end portions 808 at opposed first and second end portions of the bushing 800.

Bushing 800 further comprises at each opposite longitudinal end an inner rigid sleeve 820a, 820b bonded or otherwise affixed to part of the inner elastomeric layer 805. These rigid sleeves 820a, 820b may be formed as annuluses (bands) of the same diameter that extend over only a short length (e.g. 4 to 15 mm) of the bushing 800 in the longitudinal (axial) direction. These rigid sleeves 820a, 820b may nest in behind the flanged end portions 808.

In some embodiments, the inner elastomeric layer 805 may have a thickness extending radially outward from wall surface 806 to an outer rigid sleeve 860. In such embodiments, the inner elastomeric layer 805 forms a unitary (integrally formed) layer. Alternatively, bushing 800 may further comprise a second, intermediate elastomeric layer 840 that is bonded or otherwise affixed to the outside of the inner elastomeric layer 805. In such embodiments, the inner elastomeric layer 805 and intermediate elastomeric layer 840 effectively form a composite layer, with the inner elastomeric layer defining the bore 807. The outer metal sleeve 860 is bonded or otherwise affixed to an outside of the inner elastomeric layer 805 or to the intermediate elastomeric layer 840, depending on the embodiment.

The inner elastomeric layer 805, the inner sleeves 820a, 820b, (optionally) the intermediate elastomeric layer 840 and the outer sleeve 860 are all generally co-axial and concentric about the bore 807. The outer sleeve 860 is to be received within a bore of a suspension arm (not shown) in a tight interference fit and a suitable clevis pin (not shown) is to be received within bore 807 in order to couple the suspension arm to a part of the vehicle undercarriage.

The inner and outer sleeves 820a, 820b, 860 may be formed of hollow steel tubes or tube sections, for example, while the inner and intermediate elastomeric layers 805, 840 may be formed of softer and more flexible materials, for example. In some embodiments, inner and outer rigid sleeves 820a, 820b, 860 may be formed of other rigid materials, such as nylon 6-6, non-ferrous metals or rigid plastics, for example. Further, some embodiments of the rigid sleeves 820a, 820b may be formed of polyester or metal rings or bands that may be spirally wound, for example.

If elastomeric layer 840 is present as a distinct layer from inner elastomeric layer 805, then the durometer of the intermediate elastomeric layer 840 may be less than the durometer of the inner elastomeric layer 805. Where the intermediate elastomeric layer 840 has a lower durometer, it provides the bushing 800 with better cushioning and flexion in response to articulation forces applied to the suspension. At the same time, the rigidity of the inner sleeves 820a, 820b avoids the tendency for a gap to form between the clevis pin and the inner elastomeric layer 805 when large twisting forces are applied to the bushing 800.

In some embodiments, the elastomeric layers described herein may comprise synthetic elastomers, such as polyurethane materials (either open cast or thermoformed) or may comprise rubber materials, for example. Some embodiments may use one type of elastomeric material in one layer and another type of elastomeric material in another layer. For example, inner elastomeric layer 805 may be formed of a urethane material, while intermediate elastomeric layer 840 (if present and distinct) may be formed of a rubber material.

As shown in FIGS. 8A, 8B and 8C, bushing 800 has the inner elastomeric layer 805 formed to have channels 848 extending in a lengthwise direction and circumferentially. The channels 848 serve to allow greater flexion of the outer sleeve 860 relative to the inner sleeve 820a, 820b in various axes of rotation. Unlike other embodiments described above, the channels 848 may not be circumferentially interrupted by lands.

The inner elastomeric layer 805 may have a knurl formed on the inside wall 806 in order to accommodate and retain lubricant between the wall 806 and the clevis pin (or other rod) extending through bore 807. Alternatively, the inner wall 806 may have a PTFE (Teflon) fabric lining attached during the moulding process to act as a friction-reduction lining material surrounding the bore 807.

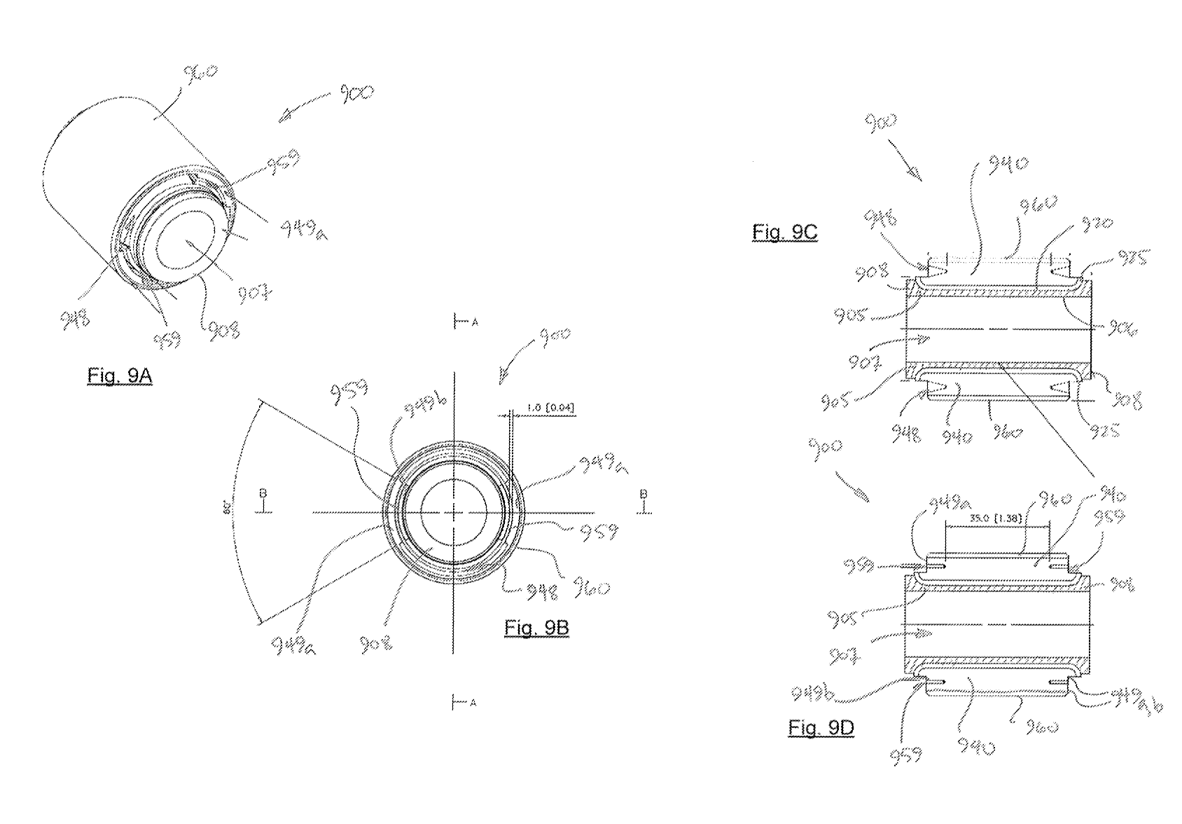

Referring now to FIGS. 9A, 9B and 9C, a bushing 900 according to some embodiments is described in further detail. Bushing 900 comprises an inner elastomeric layer 905 that has an internal substantially cylindrical wall surface 906 defining a central bore 907. The inner elastomeric layer 905 has radially outwardly flanged end portions 908 at opposed first and second end portions of the bushing 900.

Bushing 900 further comprises an inner metal sleeve 920 bonded or otherwise affixed to an outside of the inner elastomeric layer 905. This metal sleeve 920 has radially outwardly curving flanges 925 at each opposite end of the bushing 900. These radially outwardly curving flanges 925 generally nest in under the flanges 908 of the inner elastomeric layer 905, which also project radially outwardly.

Bushing 900 further comprises a second, intermediate elastomeric layer 940 that is bonded or otherwise affixed to the outside of the inner metal sleeve 920. Bushing 900 further comprises an outer metal sleeve 960 that is bonded or otherwise affixed to an outside of the intermediate elastomeric layer 940.

The inner elastomeric layer 905, the inner sleeve 920, the intermediate elastomeric layer 940 and the outer sleeve 960 are all generally co-axial and concentric about the bore 907. The outer sleeve 960 is to be received within a bore of a suspension arm (not shown) in a tight interference fit and a suitable clevis pin (not shown) is to be received within bore 907 in order to couple the suspension arm to a part of the vehicle undercarriage.

The inner and outer sleeves 920, 960 may be formed of hollow steel tubes, for example, while the inner and intermediate elastomeric layers 905, 940 may be formed of softer and more flexible materials, for example. In some embodiments, inner and outer sleeves 920, 960 may be formed of other rigid materials, such as non-ferrous metals or rigid plastics, for example. A specific non-metallic material of inner sleeve 920 and/or outer sleeve 960 in some embodiments is nylon, a suitable example of which is nylon 6-6. In some embodiments, one of inner sleeve 920 and outer sleeve 960 may be formed of a rigid metal while the other of inner sleeve 920 and outer sleeve 960 may be formed of a non-metal, such as nylon 6-6. Preferably, the durometer of the intermediate elastomeric layer 940 is less than the durometer of the inner elastomeric layer 905. Where the intermediate elastomeric layer 940 has a lower durometer, it provides the bushing 900 with better cushioning and flexion in response to articulation forces applied to the suspension. At the same time, the rigidity of the inner sleeve 920 avoids the tendency for a gap to form between the clevis pin and the inner elastomeric layer 905 when large twisting forces are applied to the bushing 900.

In some embodiments, the elastomeric layers described herein may comprise synthetic elastomers, such as polyurethane materials (either open cast or thermoformed) or may comprise rubber materials, for example. Some embodiments may use one type of elastomeric material in one layer and another type of elastomeric material in another layer. For example, inner elastomeric layer 905 may be formed of a urethane material, while intermediate elastomeric layer 940 may be formed of a rubber material.

As shown in FIGS. 9A, 9B, 9C and 9D, bushing 900 has the intermediate elastomeric layer 940 formed to have channels 948 extending in a lengthwise direction and partially circumferentially. These channels 948 may be diametrically opposed and are separated by diametrically opposed lands 949. The channels 948 and lands 949 serve to allow greater flexion of the outer sleeve 960 relative to the inner sleeve 920 in certain axes of rotation, while decreasing the degree of flexion permitted about an axis generally perpendicular to a plane coinciding with line B-B of FIG. 9B extending through a centre of the lands 949. The lands 949 are in fact made up of outer and inner lands 949a and 949b, respectively, which are separated by narrow gap 959 along the circumferential extent of the lands 949. The narrow gap 959 may have a width of about 1 mm between the neighboring lands 949a, 949b. The presence of the narrow gap 959 allows for the relative difference in flexion noted above to occur while also limiting the degree of wear that may be experienced by the bushing as a result of flexion in the plane of line B-B. The depth of the gap 959 may be less than or equal to the depth of the channels 948, which may be around 3 to 10 mm deep, for example.

The inner elastomeric layer 905 may have a knurl formed on the inside wall 906 in order to accommodate and retain lubricant between the wall 906 and the clevis pin (or other rod) extending through bore 907. Alternatively, the inner wall 906 may have a PTFE (Teflon) fabric lining attached during the moulding process to act as a friction-reduction lining material surrounding the bore 907.

While bushings 100, 200 and 900 shown in the Figures and described above may have partly circumferential channels 148, 248, 948 formed in the outer elastomeric layer 140, 240, 940, such channels may be omitted from some embodiments and the elastomeric layer 140, 240, 940 may extend solidly in place of such channels.

Embodiments are described herein in some detail but by way of example. Accordingly, described embodiments are generally intended to be illustrative and non-restrictive. It is particularly envisioned that the various described embodiments have features that can be mixed and matched across different described embodiments in order to form further embodiments that may not be specifically shown in the drawings. For example, the crennelations of bushing parts 300 and 400 may be applied to the bushing embodiments 100, 200, 500, 800 and 900, where appropriate. Similarly, the layering and reinforcement of bushing embodiments 100, 200, 500, 800 and 900 as well as the radial outward flaring of the flanges in bushings 200 and 500, may be applied to other bushing embodiments, such as those of bushing parts 300 and 400. Accordingly, the embodiments shown in the drawings should be taken to represent only some of the embodiments described herein.

Embodiments are described herein by way of example, with reference to the drawings. The embodiments are intended to be provided by way of non-limiting example and some modifications of the described embodiments may be apparent to those of ordinary skill in the art without departing from the spirit and scope of the embodiments.

1. A bushing for a vehicle suspension, comprising:
a first rigid sleeve;
a first elastomeric layer affixed to an inside of the first sleeve;
a second rigid sleeve affixed to an inside of the first elastomeric layer; and
a second rigid elastomeric layer affixed to an inside of the second sleeve.

2. The bushing of claim 1, wherein the first elastomeric layer is bonded to the first sleeve.

3. The bushing of claim 1, wherein the second sleeve is bonded to the first elastomeric layer.

4. The bushing of claim 1, wherein the second elastomeric layer is bonded to the second sleeve.

5. The bushing of claim 1, wherein the second sleeve is flanged at opposed first and second ends.

6. The bushing of claim 5, wherein the second elastomeric layer is outwardly flanged at opposed first and second ends to at least partially overlie the flanged first and second ends of the second sleeve.

7. The bushing of claim 5, wherein the flanged first and second ends of the second sleeve at least partially overlie opposed first and second ends of the first elastomeric layer.

8. The bushing of claim 1, wherein a durometer of the second elastomeric layer is higher than a durometer of the first elastomeric layer.

9. The bushing of claim 1, wherein the second elastomeric layer is hollow to snugly accommodate a tube or rod in a freely rotating manner.

10. The bushing of claim 1, wherein the first sleeve, the second sleeve, the first elastomeric layer and the second elastomeric layer are coaxially and/or concentrically arranged.

11. The bushing of claim 1, wherein the first elastomeric layer has a greater radial thickness than the second elastomeric layer.

12. The bushing of claim 1, wherein the first elastomeric layer comprises one of a rubber material and a polyurethane material.

13. The bushing of claim 1, wherein the second elastomeric layer comprises a polyurethane material.

14. The bushing of claim 1, wherein the second elastomeric layer comprises axially directed crennelations formed in opposed first and second ends where the second elastomeric layer may abut a clevis.

15. The bushing of claim 1, wherein at least one of the first rigid sleeve and the second rigid sleeve is formed of metal.

16. The bushing of claim 1, wherein at least one of the first rigid sleeve and the second rigid sleeve is formed of nylon.

17. A two-part bushing for a vehicle suspension comprising:
a first bushing part and an opposable second part, each having a first end and an opposite second end, the first and second bushing parts forming the bushing when opposed at their first ends;
wherein each of the first and second bushing parts comprise an inner rigid sleeve, an intermediate elastomeric layer affixed to the inner sleeve and an outer rigid sleeve affixed to the intermediate elastomeric layer.

18. The bushing of claim 17, wherein the outer rigid sleeve comprises a metal sleeve and wherein the bushing further comprises an outer elastomeric layer affixed to the outer rigid sleeve.

19. The bushing of claim 17, wherein at least one of the inner rigid sleeve and the outer rigid sleeve comprises a nylon material.

20. The bushing of claim 17, further comprising an inner elastomeric layer disposed radially inside the inner sleeve and affixed to the inner sleeve.

21. The bushing of claim 20, wherein the inner elastomeric layer of the first and second bushing parts projects axially beyond the inner sleeve.

22. The bushing of claim 20, wherein the inner sleeve of each of the first and second bushing parts is flanged at the second end.

23. The bushing of claim 22, wherein the inner elastomeric layer of each of the first and second bushing parts is outwardly flanged at the second end to at least partially overlie the flanged inner sleeve.

24. The bushing of claim 17, wherein the outer sleeve of each of the first and second bushing parts has a radially outwardly extending flange disposed toward the second end of the respective first and second bushing part.

25. The bushing of claim 17, wherein the inner elastomeric layer of each of the first and second bushing parts comprises axially directed crennelations at the second end.

26. The bushing of claim 17, wherein the first and second bushing parts comprise mating keying structure to cause the first and second bushing parts to rotate together when the first and second bushing parts are opposed and abutting at their first ends.

27. The bushing of claim 26, wherein the keying structure is defined by the intermediate elastomeric layer of each first and second part.

28. The bushing of claim 26, wherein the inner sleeve comprises the keying structure.

29. (canceled)

30. (canceled)

31. (canceled)

32. (canceled)

33. (canceled)

34. (canceled)

35. (canceled)

36. (canceled)

37. A bushing for a vehicle suspension, comprising:
a first rigid outer sleeve;
an elastomeric layer affixed to an inside of the first sleeve and defining a central bore of the bushing; and
at least two coaxial second rigid sleeves affixed to the elastomeric layer and disposed one at each opposed longitudinal end of the bushing.

38. The bushing of claim 37, wherein the elastomeric layer is a composite layer comprising a first elastomeric layer and a second elastomeric layer, wherein the second elastomeric layer is affixed to the first elastomeric layer and defines the central bore of the bushing.
